(19) United States
(12) Patent Application Publication
(10) Pub. No.: US 2004/0017384 A1
(43) Pub. Date: Jan. 29, 2004

(54) Method for displaying markers and rendered waveforms

(76) Inventor: Stanley E. Jaffe, Santa Rosa, CA (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/207,278

(22) Filed: Jul. 29, 2002

(51) Int. Cl. G09G 5/00

(52) U.S. Cl. 345/629

(57) ABSTRACT

A display method depicts rendered waveforms and markers in a manner that enables a user of an instrument or system to view a marker and a rendered waveform on a display, even in regions of the display where the marker and the rendered waveform overlap. The display method defines the marker by a series of contours on the display, grades the contours in the series at positions on the display where the rendered waveform does not coincide with the contours, and interleaves display elements of the display within the contours at positions where the rendered waveform coincides with the contours. The display method is alternatively implemented in a system, which includes a driver and a display, that depicts the rendered waveform and the marker.

### BACKGROUND OF THE INVENTION

The present invention relates to instrument displays, and particularly, to presenting markers and rendered waveforms on an instrument display.

Many types of instruments render waveforms on a display. These rendered waveforms typically represent signals that are received by the instrument, or data that is acquired or processed by the instrument. Marker lines, masks and other waveform markers are often superimposed with the rendered waveforms on the instrument display, either manually through a graphical user interface, or automatically by display processing software. As examples, marker lines are manually positioned at given amplitude or time locations on an oscilloscope display, or the marker lines automatically track the amplitude transitions, signal peaks, or other features of the rendered waveform. On a spectrum analyzer display, marker lines are manually positioned at given amplitude or frequency locations, or the marker lines automatically track the peak amplitudes or other features of the rendered waveform. Masks superimposed on the display of a communication analyzer indicate whether signals represented by a rendered waveform comply with, or do not comply with, designated performance criteria.

Because the rendered waveform and marker are both presented on an instrument display, one or more overlapping regions typically result where the markers coincide with the rendered waveforms. In instruments that display the marker on top of the rendered waveform, the rendered waveform is obscured by the marker in the overlapping region. Alternatively, in instruments that display the rendered waveform on top of the marker, the marker is obscured by the rendered waveform in the overlapping region. Because either the marker or the rendered waveform is obscured in the overlapping regions, it is difficult for a user of the instrument to view the marker and the rendered waveform on the instrument display simultaneously. Accordingly, there is a need for a display method that presents a rendered waveform and a marker on a display without obscuring either the rendered waveform or the marker.

### SUMMARY OF THE INVENTION

A display method constructed according to the embodiments of the present invention depicts rendered waveforms and markers in a manner that enables a user of an instrument or system to view a marker and a rendered waveform on a display, even in regions of the display where the marker and the rendered waveform overlap. The display method includes defining the marker by a series of contours on the display, grading the contours in the series at positions on the display where the rendered waveform does not coincide with the contours, and interleaving display elements of the display within the contours at positions where the rendered waveform coincides with the contours. The display method is alternatively implemented in a system, which includes a driver and a display, that depicts the rendered waveform and the marker.

### BRIEF DESCRIPTION OF THE DRAWINGS

FIG. 1 shows a system suitable for implementing a display method constructed according to the embodiments of the present invention.

FIG. 2 shows the display method constructed according to a first embodiment of the present invention.

FIG. 3 shows an example of a rendered waveform and a marker presented on a display, provided by the display methods constructed according to the embodiments of the present invention.

FIGS. 4A-4B show detailed views of the display shown in FIG. 3.

FIG. 5 shows the display method constructed according to a second preferred embodiment of the present invention.

FIGS. 6A-6D show detailed views of sequentially set display elements provided by the display method shown in FIG. 5.

### DETAILED DESCRIPTION OF THE EMBODIMENTS

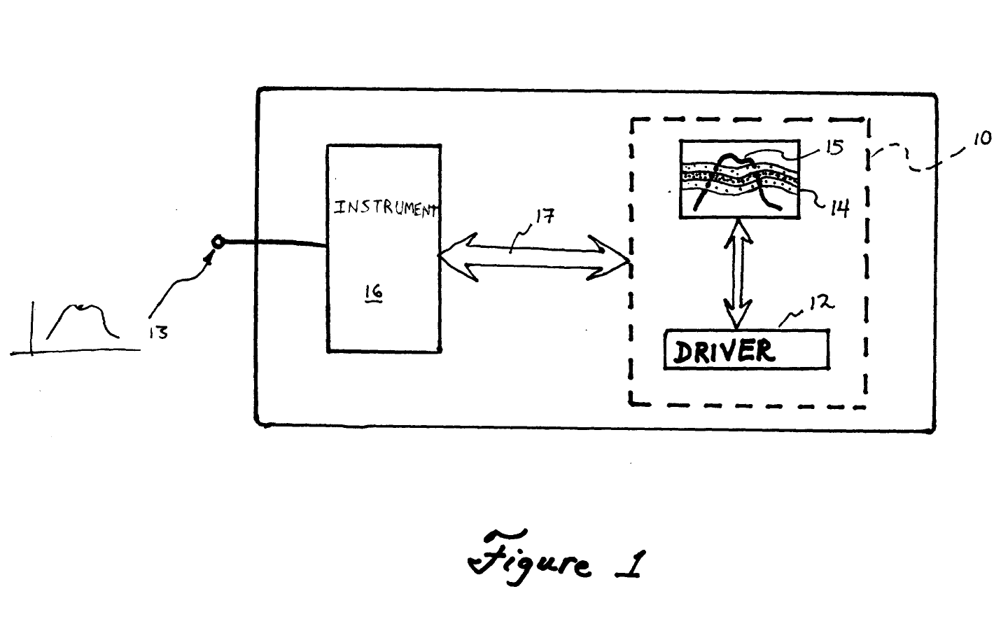

FIG. 1 shows a system 10 suitable for implementing display methods 20, 30 constructed according to the embodiments of the present invention. The system 10 includes a driver 12 and a display 14 that are either present in, or coupled to, an oscilloscope, communication analyzer, spectrum analyzer, network analyzer, signal analyzer, or any other of a variety of optical or electrical instruments 16 that render waveforms 15 on a display 14. Alternatively, the system 10 is external to the instrument 16 and coupled to the instrument 16 via a signal cable or bus, wireless communication channel, or other type of communication link 17. In modern instruments 16, the display 14 is a printer, CRT, flat panel LCD or LED screen, or other output device having a set of display elements or pixels that are suitable for depicting the rendered waveform 15. The rendered waveform 15 is typically a reconstruction of a signal 13 received by the instrument 16 or a graphical representation of data, such as data that is measured, acquired, or processed by the instrument 16. The driver 12 is a controller, processor, or computer suitable for writing to the display 14 either directly or through buffers or other memory. An example of the system 10 is a video display board (part number 86122-60028) and flat panel LCD display included in the Model 86122A Multi-Wavelength Meter, each available from AGILENT TECHNOLOGIES, INC., Palo Alto, Calif., USA.

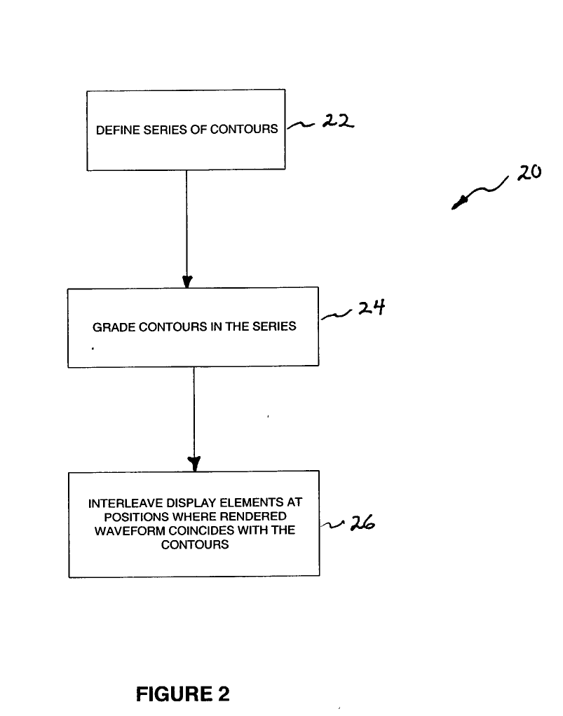

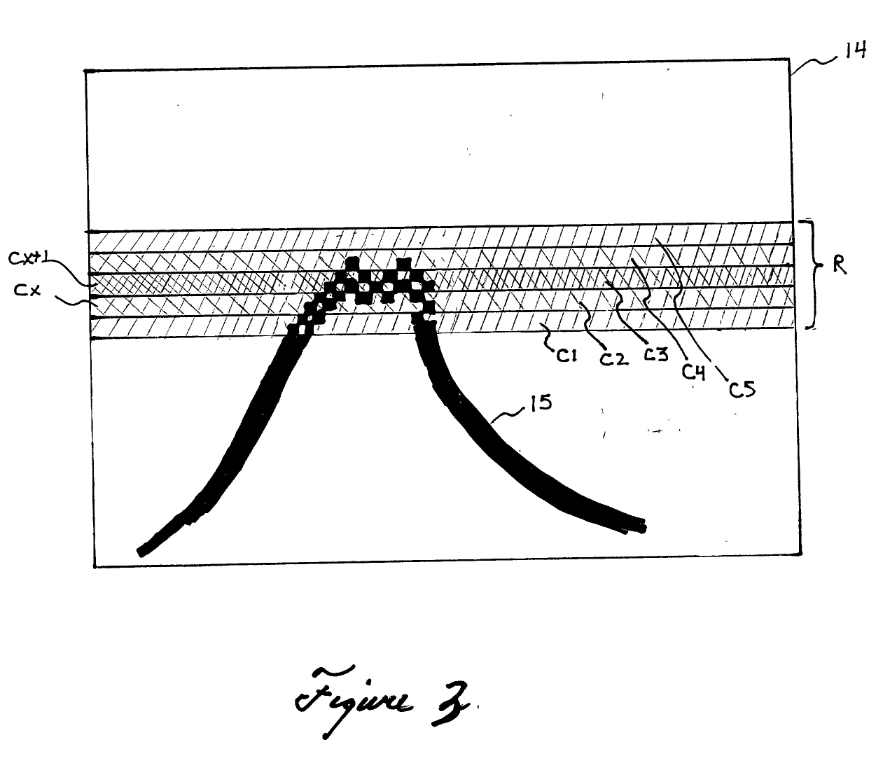

FIG. 2 shows the display method 20 constructed according to the first embodiment of the present invention. According to step 22 of the display method 20, a marker, represented by a series of contours is defined on the display 14 on which the instrument 16 presents the rendered waveform 15. FIG. 3 shows the series including five line-shaped contours designated as C1-C5. However, the series alternatively includes a different number of contours other than five, or includes contours of different shapes other than lines, depending on the particular mask, marker line, or other marker that is defined by the contours, or depending on the type or range R of parameters represented by the series of contours C1-C5. As examples, the series of contours C1-C5 represents a range R depicting different levels of voltage, current, intensity, amplitude, magnitude, or different frequencies, times, or degrees of compliance/non-compliance with a specification. Alternatively, the series of contours C1-C5 represents any other parameter or range R of parameters associated with the rendered waveform 15.

In step 24 of the display method 20, each contour, designated for example as contour CX, is graded relative to adjacent contours, designated as contours CX+1, CX−1 in the series via shading, coloring, hatching or other visually distinguishing features, achieved by settings of the display elements lying within the contour CX. In the example shown in FIG. 3, different hatching of the contours C1-C5 is used to indicate a grading of the contours C1-C5 based on color.

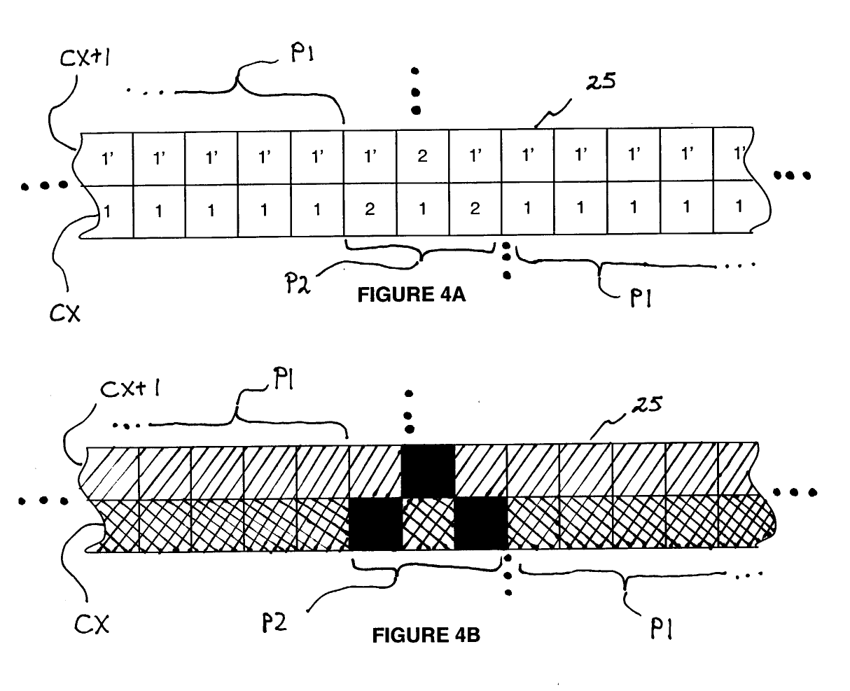

FIG. 4A shows a detailed view of the settings of the display elements 25 of the display 14 within the two adjacent contours CX, CX+1. For each contour CX in the series, at positions P1 on the display 14 where the rendered waveform 15 does not coincide with the contour CX, the display elements 25 within the contour CX are set to a first state 1. The first state 1 is an activation or setting of display elements 25 within the contour CX that produces the shading, coloring, hatching or the other visually distinguishing feature that grades the particular contour CX. The first state 1 that defines the grading of one contour CX in the series is distinct from the first state 1′ that defines the grading of the adjacent contour CX+1 in the series, resulting in the contours C1-C5 in the series that are adjacent to one another being visually distinguished. FIG. 4B shows the resulting display 14 that corresponds to the settings of the display elements 25 that are shown in FIG. 4A.

In step 26 of the display method 20, display elements 25 within the contours C1-C5 are interleaved at positions P2 on the display 14 where the rendered waveform 15 coincides with the contours C1-C5 in the series. For each contour CX in the series, at the positions P2 where the rendered waveform 15 coincides with the contour CX, adjacent display elements 25 are interleaved by an alternating setting of the display elements 25 within the contour CX to the first state 1 and a second state 2. The first state 1, 1′ is that setting of the display elements 25 that defines the grading of the contours CX, CX+1 and the second state 2 is that setting of the display elements 25 that depicts the rendered waveform 15 on the display 14. The second state 2, for example, defines the color of the rendered waveform 15, distinguishing the rendered waveform 15 from a background of the display 14 and from the first states that define the grading of each of the contours C1-C5 in the series.

The alternating settings of display elements 25 of the display 14 to the first and second states 1, 2 (shown in FIG. 4A) provide a checkered pattern (shown in FIG. 4B) at the position P2 where the rendered waveform 15 coincides with the contours C1-C5 in the series. However, depending on the size of the display elements 25 of the display 14, the type of display 14, or the distance from which the display 14 is observed, the checkered pattern gives the rendered waveform 15 and the contours C1-C5 an appearance of either being checkered, or of being translucent to a viewer of the display 14 where the rendered waveform 15 and the contours C1-C5 coincide, enabling the viewer to observe both the rendered waveform 15 and the contours C1-C5 without either the rendered waveform 15 or the contours C1-C5 being obscured.

The display 14 of the rendered waveform 15 and the series of contours C1-C5 resulting from the method 20 is provided by setting the display elements 25 within each contour CX in the series to either the first state 1, 1′ or the second state 2, depending on whether or not the rendered waveform 15 coincides with the contours C1-C5. However, the setting the of the display elements 25 to provide the resulting displays 14 of the rendered waveform 15 and the contours C1-C5, as shown in the examples of FIG. 3 and FIGS. 4A-4B, is alternatively achieved by a sequential setting of the display elements 25 within the contours C1-C5.

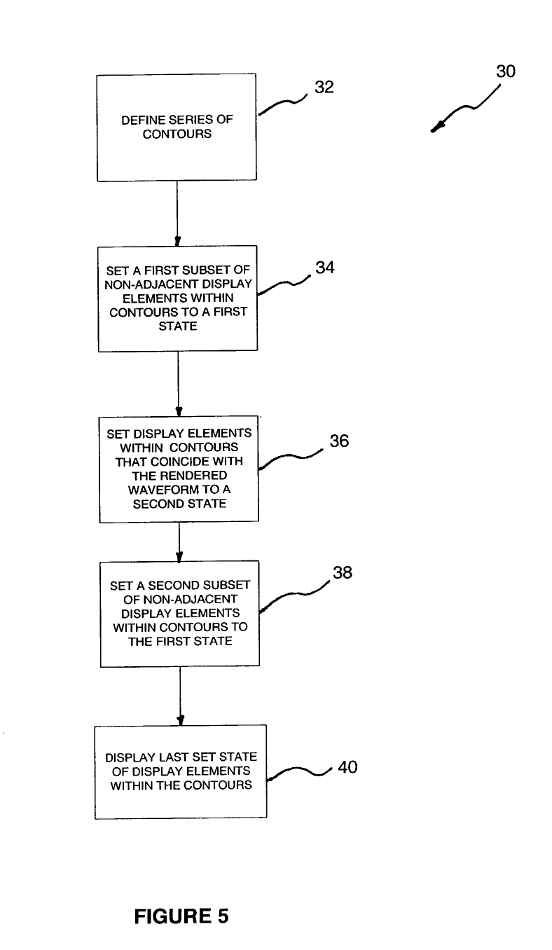

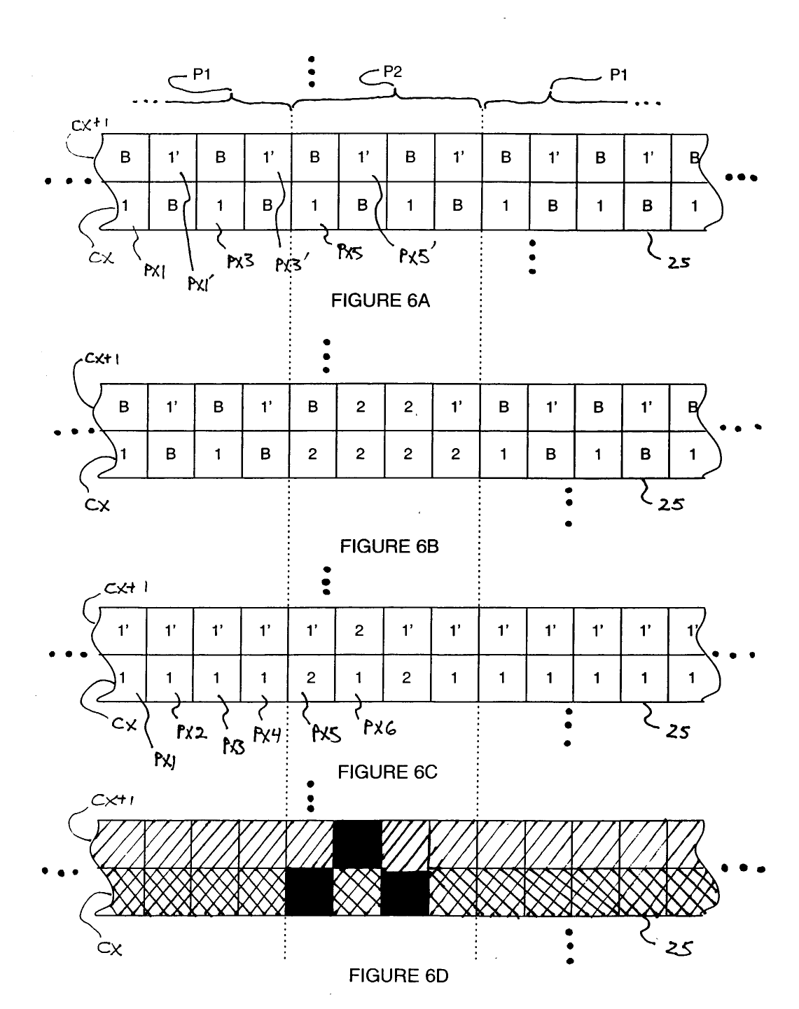

FIG. 5 shows a flow diagram of an alternative display method 30 constructed according to a second embodiment of the present invention. In step 32 of the display method 30, the series of contours C1-C5 is defined on the display 14 on which the instrument 16 presents the rendered waveform 15. In step 34, each contour CX in the series a first subset (PX1, PX3, PX5 . . . ) of non-adjacent display elements is set to the first state 1 as shown in FIG. 6A. The first subset (PX1, PX3, PX5 . . . ) includes non-adjacent ones of the display elements 25 of the display 14 within the contour CX, for example, odd pixels of the display 14 within the contour CX. While the first state is indicated by the reference “1”, the reference “B” indicates a setting of the display elements 25 to a background state B that is used to designate the background of the display 14, over which the rendered waveform 15 and contours C1-C5 are presented.

Then, in step 36, display elements 25 within the contour CX that coincide with the rendered waveform 15 are set to the second state 2, indicated by a reference “2” (shown in FIG. 6B). As a result of step 36, display elements 25 in the first subset (PX1, PX3, PX5 . . . ) and display elements set to the background state B, which coincide with the rendered waveform 15 in the contour CX, are overwritten and set to the second state 2. In step 38, a second subset (PX2, PX4, PX6 . . . ) of non-adjacent display elements within the contour is also set to the first state 1. The second subset (PX2, PX4, PX6 . . . ) includes non-adjacent display elements within the contour CX, for example, even pixels of the display 14 within the contour CX. As a result, display elements 25 in the second subset (PX2, PX4, PX6 . . . ) that coincide with the rendered waveform 15 and display elements 25 set to the background state B, are overwritten and set to the first state 1. The last set state of each display element 25 in the contours is presented in step 40 so that the settings of the display elements 25 of the display 14 within the contours CX, CX+1 shown in FIG. 6C are equivalent to the settings of the display elements 25 in FIG. 4B, and the resultant display 14 of FIG. 6D is equivalent to that of FIG. 4B.

To achieve the checkered pattern, the first subset (PX1, PX3, PX5 . . . ) of display elements 25 of the contour CX is also selected to be offset relative to the first subset (PX1′, PX3′, PX5′ . . . ) of an adjacent contour CX+1 so that the first subset (PX1′, PX3′, PX5′ . . . ) of the adjacent contour CX+1 aligns vertically with the second subset (PX2, PX4, PX6 . . . ) of the contour CX.

While the embodiments of the present invention have been illustrated in detail, it should be apparent that modifications and adaptations to these embodiments may occur to one skilled in the art without departing from the scope of the present invention as set forth in the following claims.

What is claimed is:

1. A method for depicting a rendered waveform and a marker on a display, comprising:
defining the marker by a series of contours on the display;
grading the contours in the series at positions on the display where the rendered waveform does not coincide with the contours in the series; and
interleaving a plurality of display elements of the display within the contours in the series at positions where the rendered waveform coincides with the contours in the series.

2. The method of claim 1 wherein grading the contours in the series includes, for each contour in the series, a setting of at least one display element within the contour to a first state, and wherein interleaving a plurality of display elements includes for each contour in the series, an alternating setting of at least one display element within the contour to the first state, with at least one display element within the contour to a second state, the second state depicting the rendered waveform on the display.

3. The method of claim 2 wherein each contour in the series is adjacent to at least one other contour in the series, the first state of one contour in the series being distinct from the first state of the at least one other adjacent contour in the series.

4. The method of claim 3 wherein the first state for each contour in the series defines a feature of the contour including at least one of a color, a shading and a hatching for the contour.

5. The method of claim 2 wherein grading the contours in the series and interleaving a plurality of display elements includes setting a first subset of non-adjacent display elements within each contour to the first state, setting to the second state display elements within each contour that coincide with the rendered waveform, setting a second subset of non-adjacent display elements within each contour to the first state wherein the non-adjacent display elements of the first subset are adjacent to the non-adjacent display elements of the second subset, and presenting on the display a last setting of each of the display elements within the first subset and the second subset.

6. The method of claim 5 wherein each contour in the series is adjacent to at least one other contour in the series, the first state of one contour in the series being distinct from the first state of the at least one other adjacent contour in the series.

7. The method of claim 6 wherein the first state for each contour in the series defines a feature of the contour including at least one of a color, a shading and a hatching for the contour.

8. A computer readable medium carrying one or more sequences of instructions causing one or more processors to depict a rendered waveform and a marker on a display, the one or more sequences of instructions, comprising:
defining the marker by a series of contours on the display;
grading the contours in the series at positions on the display where the rendered waveform does not coincide with the contours in the series; and
interleaving a plurality of display elements of the display within the contours in the series at positions where the rendered waveform coincides with the contours in the series.

9. The computer readable medium of claim 8 wherein grading the contours in the series includes, for each contour in the series, a setting of at least one display element within the contour to a first state, and wherein interleaving a plurality of display elements includes for each contour in the series, an alternating setting of at least one display element within the contour to the first state, with at least one display element within the contour to a second state, the second state depicting the rendered waveform on the display.

10. The computer readable medium of claim 9 wherein each contour in the series is adjacent to at least one other contour in the series, the first state of one contour in the series being distinct from the first state of the at least one other adjacent contour in the series.

11. The computer readable medium of claim 10 wherein the first state for each contour in the series defines a feature of the contour including at least one of a color, a shading and a hatching for the contour.

12. The computer readable medium of claim 9 wherein grading the contours in the series and interleaving a plurality of display elements includes setting a first subset of non-adjacent display elements within each contour to the first state, setting to the second state display elements within each contour that coincide with the rendered waveform, setting a second subset of non-adjacent display elements within each contour to the first state wherein the non-adjacent display elements of the first subset are adjacent to the non-adjacent display elements of the second subset, and presenting on the display a last setting of each of the display elements within the first subset and the second subset.

13. The computer readable medium of claim 12 wherein each contour in the series is adjacent to at least one other contour in the series, the first state of one contour in the series being distinct from the first state of the at least one other adjacent contour in the series.

14. The computer readable medium of claim 13 wherein the first state for each contour in the series defines a feature of the contour including at least one of a color, a shading and a hatching for the contour.

15. A system for displaying a rendered waveform and a marker, comprising:
a display presenting the rendered waveform;
a driver coupled to the display, defining the marker by a series of contours on the display, for each contour in the series the driver setting at least one display element of the display within the contour to a first state at positions on the display where the rendered waveform does not coincide with the contour, and for each contour in the series the driver activating at positions on the display where the rendered waveform coincides with the contour, an alternating setting of at least one display element within the contour to a first state with at least one display element within the contour to a second state, the second state depicting the rendered waveform on the display.

16. The system of claim 15 wherein each contour in the series is adjacent to at least one other contour in the series, the first state of one contour in the series being distinct from the first state of the at least one other adjacent contour in the series.

17. The system of claim 16 wherein the first state for each contour in the series defines a feature of the contour including at least one of a color, a shading and a hatching for the contour.

18. The system of claim 15 wherein setting at least one display element of the display within the contour to a first state at positions on the display where the rendered waveform does not coincide with the contour and activating at positions on the display where the rendered waveform coincides with the contour, an alternating setting of at least one display element within the contour to a first state with at least one display element within the contour to a second state includes the driver setting a first subset of non-adjacent display elements within each contour to the first state, setting to the second state display elements within each contour that coincide with the rendered waveform, setting a second subset of non-adjacent display elements within each contour to the first state wherein the non-adjacent display elements of the first subset are adjacent to the non-adjacent display elements of the second subset, and presenting on the display a last setting of each of the display elements within the first subset and the second subset.

19. The system of claim 18 wherein each contour in the series is adjacent to at least one other contour in the series, the first state of one contour in the series being distinct from the first state of the at least one other adjacent contour in the series.

20. The system of claim 19 wherein the first state for each contour in the series defines a feature of the contour including at least one of a color, a shading and a hatching for the contour.
